(19) United States
(12) Patent Application Publication
(10) Pub. No.: US 2007/0175214 A1
(43) Pub. Date: Aug. 2, 2007

(54) Turbocharger having divided housing with nozzle vanes

(76) Inventors: Paul W. Reisdorf, Dunlap, IL (US); Anees Hafiz, Peoria, IL (US); Kerry A. Delvecchio, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/341,669

(22) Filed: Jan. 30, 2006

(51) Int. Cl. F02B 29/04; F02B 33/44

(52) U.S. Cl. 60/599; 60/605.1

(57) ABSTRACT

A turbocharger for a power system is disclosed. The turbocharger has a turbine wheel and a housing configured to at least partially enclose the turbine wheel. The housing has a first turbine volute configured to fluidly communicate exhaust gases with the turbine wheel, a second turbine volute configured to fluidly communicate exhaust gases with the turbine wheel, a wall member axially separating the first and second turbine volutes. The housing also has a first plurality of annularly disposed vane members associated with at least one of the first and second turbine volutes.

### TECHNICAL FIELD

The present disclosure is directed to a turbocharger and, more particularly, to a turbocharger having a divided housing with nozzle vanes.

### BACKGROUND

Internal combustion engines such as, for example, diesel engines, gasoline engines, and gaseous fuel powered engines are supplied with a mixture of air and fuel for subsequent combustion within the engine that generates a mechanical power output. In order to maximize the power generated by this combustion process, the engine is often equipped with a turbocharged air induction system.

A turbocharged air induction system includes a turbocharger that uses exhaust from the engine to compress air flowing into the engine, thereby forcing more air into a combustion chamber of the engine then the engine could otherwise draw into the combustion chamber. This increased supply of air allows for increased fuelling, resulting in an increased power output. A turbocharged engine typically produces more power than the same engine without turbocharging.

A conventional turbocharger includes a turbine housing having a single volute, a turbine wheel centrally disposed to receive exhaust from the volute, and a shaft connecting the turbine wheel to a compressor. As exhaust is forced from each combustion chamber of the engine, it is directed through the volute to the turbine wheel, to rotate the turbine wheel and connected compressor.

Variations of the conventional turbocharger are available. For example, in some applications, the volute is divided into two or “twin” volutes disposed axially within respect to each other, with each volute directing exhaust from different combustion chambers of the engine to the entire periphery of an associated turbine wheel. Each volute is associated with those combustion chambers firing at approximately the same time, such that the pulses of pressurized exhaust exiting the combustion chambers may be efficiently directed to the turbine wheel, while minimizing undesirable pulse interactions within the engine. In other applications, the typical turbocharger is modified to include a nozzle ring. A nozzle ring includes a plurality of annularly arranged vanes that act to direct the exhaust flow from the volute uniformly to the turbine wheel.

One air induction system utilizing a non-typical turbine with similar variations is described in U.S. Pat. No. 3,137,477 (the '477 patent) issued to Kofink on Jun. 16, 1964. Specifically, the '477 patent describes a supercharger having a turbine with two inlet flow channels and a plurality of vanes connected by a nozzle ring. Gas is directed through a first of the flow channels to a first group of the radially arranged vanes, and through a second of the flow channels to the remaining radially arranged vanes. The turbine wheel is concentrically arranged in respect to the vanes. Four areas around the nozzle ring include baffles to block the flow of gas through radially aligned vanes. During operation of the supercharger, the orientation of the nozzle ring is adjusted with respect to the baffles for the purpose of cutting down the flow area through the nozzles when the operating conditions require the handling of a lesser volume of gas.

Although the supercharger of the '477 patent may have two inlet flow channels and associated vanes, it does not receive the benefits associated with twin volutes and a conventional nozzle ring. In particular, the two inlet flow channels are not volutes and do not separately distribute air flow equally to the entire periphery of a turbine wheel. In contrast, because the two inlet flow channels are radially arranged with respect to each other rather than axially arranged and each of the two inlet flow channels only serves a radial portion of the vanes and turbine wheel, the load on the turbine wheel may be imbalanced resulting in shortened component life of the supercharger. In addition, because some of the vanes are blocked from gas flow, the nozzle ring of the '477 patent may fail to direct gas flow to the turbine wheel in a sufficiently uniform manner.

The turbocharger of the present disclsoure solves one or more of the problems set forth above.

### SUMMARY OF THE INVENTION

In one aspect, the present disclosure is directed to a turbocharger. The turbocharger includes a turbine wheel and a housing configured to at least partially enclose the turbine wheel. The housing has a first turbine volute configured to fluidly communicate exhaust with the turbine wheel, a second turbine volute configured to fluidly communicate exhaust with the turbine wheel, and a wall member axially separating the first and second turbine volutes. The housing also has a first plurality of annularly disposed vane members associated with at least one of the first and second turbine volutes.

In another aspect, the present disclosure is directed to a method of operating a turbocharger. The method includes receiving a first flow of exhaust into the turbocharger and simultaneously receiving a second flow of exhaust into the turbocharger at an offset axially location separate from the first. The method also includes radially redirecting at least one of the first and second flows of exhaust at a plurality of finite annular locations.

### BRIEF DESCRIPTION OF THE DRAWINGS

FIG. 1 is a schematic illustration of an exemplary disclosed power system;

FIG. 2 is an oblique view cutaway illustration of an exemplary disclosed turbocharger for use with the power system of FIG. 1; and

FIG. 3 is a side view cross-sectional illustration of the turbocharger of FIG. 2.

### DETAILED DESCRIPTION

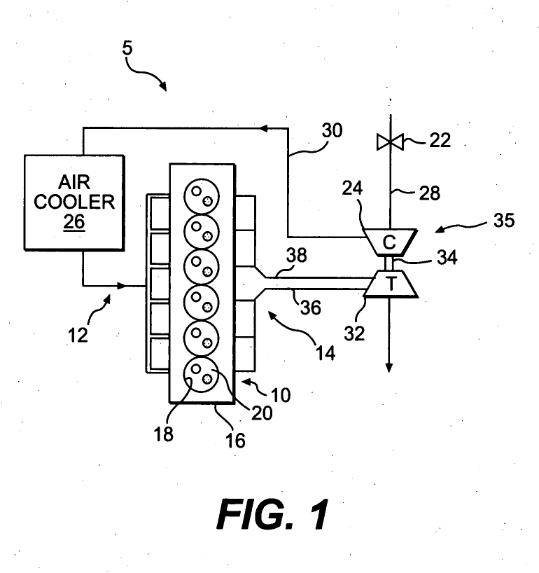

FIG. 1 illustrates a power system 5 having a power source 10, an air induction system 12, and an exhaust system 14. For the purposes of this disclosure, power source 10 is depicted and described as a four-stroke diesel engine. One skilled in the art will recognize, however, that power source 10 may be any other type of internal combustion engine such as, for example, a gasoline or a gaseous fuel-powered engine. Power source 10 may include an engine block 16 that defines a plurality of cylinders 18. A piston (not shown) may be slidably disposed within each cylinder 18 to reciprocate between a top-dead-center position and a bottom-dead-center position, and a cylinder head (not shown) may be associated with each cylinder 18.

Cylinder 18, the piston, and the cylinder head may form a combustion chamber 20. In the illustrated embodiment, power source 10 includes six such combustion chambers 20. However, it is contemplated that power source 10 may include a greater or lesser number of combustion chambers 20 and that combustion chambers 20 may be disposed in an “in-line” configuration, a “V” configuration, or in any other suitable configuration.

Air induction system 12 may include components configured to introduce charged air into power source 10. For example, air induction system 12 may include an induction valve 22, one or more compressors 24, and an air cooler 26. It is contemplated that additional components may be included within air induction system 12 such as, for example, additional valving, one or more air cleaners, one or more waste gates, a control system, a bypass circuit, and other means for introducing charged air into power source 10. It is also contemplated that induction valve 22 and/or air cooler 26 may be omitted, if desired.

Induction valve 22 may be connected to compressors 24 via a fluid passageway 28 and configured to regulate the flow of atmospheric air to power source 10. Induction valve 22 may embody a shutter valve, a butterfly valve, a diaphragm valve, a gate valve, or any other type of valve known in the art. Induction valve 22 may be solenoid-actuated, hydraulically-actuated, pneumatically-actuated, or actuated in any other manner in response to one or more predetermined conditions.

Compressor 24 may be configured to compress the air flowing into power source 10 to a predetermined pressure level. Compressors 24, if more than one is included within air induction system 12, may be disposed in a series or parallel relationship and connected to power source 10 via a fluid passageway 30. Compressor 24 may embody a fixed geometry compressor, a variable geometry compressor, or any other type of compressor known in the art. It is contemplated that a portion of the compressed air from compressor 24 may be diverted from fluid passageway 30 for other uses, if desired.

Air cooler 26 may embody an air-to-air heat exchanger, an air-to-liquid heat exchanger, or a combination of both, and be configured to facilitate the transfer of thermal energy to or from the compressed air directed into power source 10. For example, air cooler 26 may include a shell and tube-type heat exchanger, a corrugated plate-type heat exchanger, a tube and fin-type heat exchanger, or any other type of heat exchanger known in the art. Air cooler 26 may be disposed with fluid passageway 30, between compressor 24 and power source 10.

Exhaust system 14 may include a means for directing exhaust flow out of power source 10. For example, exhaust system 14 may include one or more turbines 32 connected in a series or parallel relationship. It is contemplated that exhaust system 14 may include additional components such as, for example, particulate traps, NOx absorbers or other catalytic devices, attenuation devices, and other means for directing exhaust flow out of power source 10 that are known in the art.

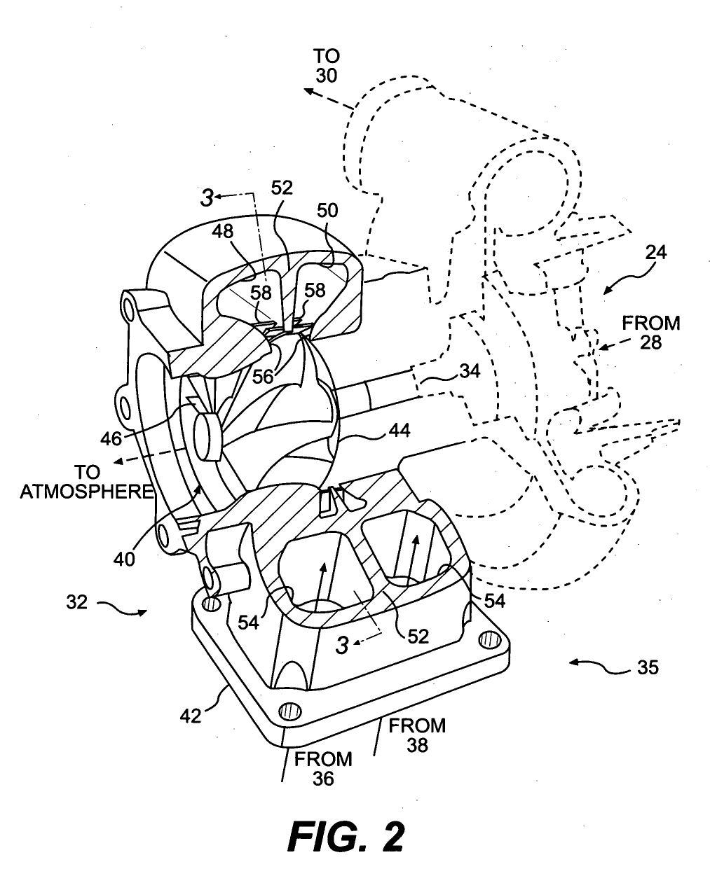

Each turbine 32 may be connected to one or more compressors 24 of air induction system 12 by way of a common shaft 34 to form a turbocharger 35. As the hot exhaust gases exiting power source 10 move through one of two exhaust passageways 36, 38 to turbine 32 and expand against blades (not shown in FIG. 1) of turbine 32, turbine 32 may rotate and drive the connected compressors 24 to compress inlet air. As illustrated in FIG. 2, turbine 32 may include a turbine wheel 40 fixedly connected to common shaft 34 and centrally disposed to rotate within a turbine housing 42.

Turbine wheel 40 may include a turbine wheel base 44 and a plurality of turbine blades 46. Turbine blades 46 may be disposed on the outer periphery of turbine wheel base 44 and may be adapted to rotate turbine wheel base 44 when driven by the expansion of hot exhaust gases. Turbine blades 46 may be rigidly fixed to the turbine wheel base 44 using conventional means or may alternatively be integral with turbine wheel base 44 and formed through a casting or forging process, if desired.

Turbine housing 42 may be configured to at least partially enclose turbine wheel 40 and direct hot expanding gases from exhaust passageways 36 and 38 separately to turbine wheel 40. In particular, turbine housing 42 may be a divided housing have a first volute 48 and a second volute 50. First volute 48 may be fluidly connected with exhaust passageway 36 such that the exhaust from a first group of combustion chambers 20 of power source 10 (referring to FIG. 1) firing at nearly the same time may be directed through exhaust passageway 36 to turbine wheel 40 via first volute 48. Second volute 50 may be fluidly connected with exhaust passageway 38 such that the exhaust from a second group of combustion chambers 20 of power source 10 firing at nearly the same time, but different from the first group, may be directed through exhaust passageway 38 to turbine wheel 40 via second volute 50. A wall member 52 may divide first volute 48 from second volute 50.

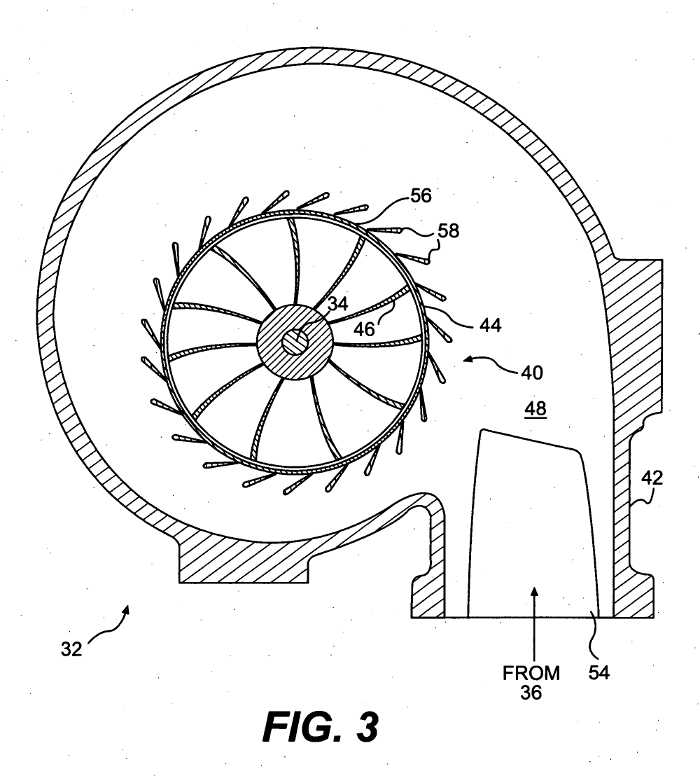

Each of first and second volutes 48, 50 may have an inlet 54 and an annular channel-like outlet 56 fluidly connecting first and second volutes 48, 50 with a periphery of turbine wheel 40. A plurality of vane members 58 may be disposed within each of first and second volutes 48, 50 between inlet 54 and the annular channel-like outlet 56. Vane members 58 may be substantially equally angled relative to a central axis of turbine 32 such that exhaust gases entering inlet 54 and flowing annularly through first and second volutes 48, 50 may be radially and uniformly redirected inward through the annular channel-like outlet 56 at a plurality of finite annular locations. As illustrated in both FIGS. 2 and 3, vane members 58 may be fixedly connected to opposing sides of wall member 52 at a plurality of equally spaced locations, thereby dividing the annular channel-like outlet 56 into the plurality of finite outlet locations. It is contemplated that vane members 58 may be cast integrally with turbine housing 42 and fabricated, for example, through an electron discharge machining process. It is also contemplated that vane members 58 may alternatively be cast integrally with turbine housing 42 in finish form through a high precision casting process. It is further contemplated that vane members 58 may be initially separate from turbine housing 42 and, when assembled thereto, may be common to both first and second volutes 48, 50 (e.g., extending through wall member 52). It is additionally contemplated that vane members 58 may only be associated with only one of first and second volutes 48, 50, if desired.

### INDUSTRIAL APPLICABILITY

The disclosed turbocharger may be implemented into any power system application where charged air induction is utilized. In particular, because the disclosed turbocharger includes both a divided turbine housing and nozzle vanes, exhaust pulse energy may be fully and efficiently utilized without undesirable interactions or uniformity losses. The operation of power system 5 will now be explained.

Referring to FIG. 1, atmospheric air may be drawn into air induction system 12 by compressor 24 via induction valve 22, where it may be pressurized to a predetermined level before entering combustion chambers 20 of power source 10. Fuel may be mixed with the pressurized air before or after entering combustion chambers 20 and combusted by power source 10 to produce mechanical work and an exhaust flow of hot gases. The exhaust flow may be directed from power source 10 to turbine 32 where the expansion of the hot gases may cause turbine 32 to rotate, thereby rotating connected compressor 24 and compressing the inlet air. After exiting turbine 32, the exhaust flow may be released to the atmosphere.

As illustrated in FIG. 2, as the exhaust gases flowing from power source 10 enter turbine 32 via exhaust passageways 36 and 38, they may be separately and simultaneously directed through first and second volutes 48, 50, respectively, to turbine wheel 40. As the flow of exhaust moves through each of first and second volutes 48, 50 and around turbine wheel 40, vane members 58 may redirect these annular flows inward to the periphery of turbine blades 46 at the plurality of finite locations. After imparting energy to and thereby urging turbine blades 46 to rotate, the exhaust gases may axially exit turbine 32.

The advantages of a divided turbine housing and nozzle vanes may both be realized in turbine 32. In particular, because turbine 32 includes divided turbine housing 42, a greater amount of the exhaust pressure pulses from combustion chambers 20 may be used to rotate turbine wheel 40, with minimal undesired pulse interactions. In addition, because turbine 32 includes vane members 58 within both first and second volutes 48, 50, the exhaust flow to turbine wheel 40 may be efficiently uniform.

It will be apparent to those skilled in the art that various modifications and variations can be made to the disclosed turbocharger. Other embodiments will be apparent to those skilled in the art from consideration of the specification and practice of the disclosed turbocharger. It is intended that the specification and examples be considered as exemplary only, with a true scope being indicated by the following claims and their equivalents.

What is claimed is:

1. A turbocharger, comprising:
a turbine wheel; and
a housing configured to at least partially enclose the turbine wheel and having:
a first turbine volute configured to fluidly communicate exhaust with the turbine wheel;
a second turbine volute configured to fluidly communicate exhaust with the turbine wheel;
a wall member axially separating the first and second turbine volutes; and
a first plurality of annularly disposed vane members associated with at least one of the first and second turbine volutes.

2. The turbocharger of claim 1, wherein the first plurality of annularly disposed vane members are fixedly connected to the wall member.

3. The turbocharger of claim 1, wherein the first plurality of annularly disposed vane members is associated with the first turbine volute and the housing further includes a second plurality of annularly disposed vane members associated with the second turbine volute.

4. The turbocharger of claim 3, wherein the second plurality of annularly disposed vane members are fixedly connected to a side of the wall member opposite the first plurality of annularly disposed vane members.

5. The turbocharger of claim 1, wherein the turbine housing is a single integral component.

6. The turbocharger of claim 5, wherein:
the turbine housing is formed through a casting process; and
the first plurality of annularly disposed vane members are fabricated through an electron discharge machining process.

7. The turbocharger of claim 5, wherein the turbine housing and first plurality of annularly disposed vane members are formed through a casting process.

8. The turbocharger of claim 1, wherein the first plurality of annularly disposed vane members are configured to direct exhaust from the first turbine volute radially inward to the turbine wheel in a substantially uniform manner.

9. The turbocharger of claim 1, wherein the first plurality of annularly disposed vane members are common to both the first and second turbine volutes.

10. A method of operating a turbocharger, comprising:
receiving a first flow of exhaust into the turbocharger;
simultaneously receiving a second flow of exhaust into the turbocharger at an axially offset location separate from the first; and
radially redirecting at least one of the first and second flows of exhaust at a plurality of finite annular locations.

11. The method of claim 10, wherein the annular locations are spaced substantially equally about the periphery of a turbine wheel.

12. The method of claim 10, further including simultaneously, separately, and radially redirecting both of the first and second flows of exhaust at the plurality of finite annular locations.

13. A power system, comprising:
a power source having a plurality of combustion chambers and being configured to produce a power output and a flow of exhaust gases;
a first exhaust passageway associated with at least a first of the plurality of combustion chambers;
a second exhaust passageway associated with at least a second of the plurality of combustion chambers; and
a turbocharger in fluid communication with the first and second exhaust passageways, the turbocharger including:
a turbine wheel; and
a housing configured to at least partially enclose the turbine wheel and having:
a first turbine volute configured to fluidly communicate the exhaust gases with the turbine wheel;
a second turbine volute configured to fluidly communicate the exhaust gases with the turbine wheel;
a wall member axially separating the first and second turbine volutes;
a first plurality of annularly disposed vane members associated with the first turbine volute; and
a second plurality of annularly disposed vane members associated with the second turbine volute.

14. The power system of claim 13, wherein:
the first plurality of annularly disposed vane members are fixedly connected to the wall member; and
the second plurality of annularly disposed vane members are fixedly connected to a side of the wall member opposite the first plurality of annularly disposed vane members.

15. The power system of claim 13, wherein the turbine housing is a single integral component.

16. The power system of claim 15, wherein:
the turbine housing is formed through a casting process; and
the first plurality of annularly disposed vane members are fabricated through an electron discharge machining process.

17. The power system of claim 15, wherein the turbine housing and first plurality of annularly disposed vane members are formed through a casting process.

18. The power system of claim 13, wherein:
the first plurality of annularly disposed vane members are configured to direct the exhaust gases from the first turbine volute radially inward to the turbine wheel in a substantially uniform manner; and
the second plurality of annularly disposed vane members are configured to direct the exhaust gases from the second turbine volute radially inward to the turbine wheel in a substantially uniform manner.

19. The power system of claim 13, wherein the first plurality of annularly disposed vane members are common to both the first and second turbine volutes.

20. The power system of claim 13, wherein the first and second plurality of annularly disposed vane members are spaced substantially equally around a periphery of the turbine wheel.
